(19) United States
(12) Patent Application Publication
(10) Pub. No.: US 2026/0217990 A1
(43) Pub. Date: Jul. 30, 2026

(54) POLYDIMETHYLSILOXANE WITH HIGH LOADING OF MICA

(71) Applicant: Dow Silicones Corporation, Midland, MI (US)

(72) Inventors: Craig F. Gorin, Midland, MI (US); Michael Hartmann, Nieder-Olm (DE); Ryan Thomas, Freeland, MI (US); Jason Suhr, Coleman, MI (US); Chi-Hao Chang, Midland, MI (US); Bizhong Zhu, Midland, MI (US)

(21) Appl. No.: 19/145,093

(22) PCT Filed: Jan. 11, 2024
(86) PCT No.: PCT/US2024/011163

§ 371 Date: Jul. 1, 2025

Related U.S. Application Data
(60) Provisional application No. 63/441,043, filed on Jan. 25, 2023.

(51) Int. Cl. C09D 5/18; C08G 77/12; C08G 77/20; C08K 3/22; C08K 3/34; C09D 7/40; C09D 7/61; C09D 183/04; H01M 50/122; H01M 50/124

(52) U.S. Cl. CPC C09D 5/18; C08G 77/12; C08G 77/20; C09D 7/61; C09D 7/69; C09D 183/04; H01M 50/122; H01M 50/124; C08K 2003/2227; C08K 2003/343; C08K 2201/005; C08K 2201/014

(57) ABSTRACT

The present invention relates to a composition comprising a) a polyorganosiloxane functionalized with at least two Si—H groups; b) a polyorganosiloxane functionalized with at least two vinyl groups; c) micron-sized mica particles; and d) a hydrosilylation catalyst; wherein the concentration of the mica particles is in the range of from 90 to 200 parts by weight per 100 parts by weight of polyorganosiloxanes a) and b). The composition of the present invention is useful as coating material that can be applied to a battery pack casing or cover to protect against the consequences of thermal runaway.

### BACKGROUND OF THE INVENTION

The present invention relates to a composition comprising a polydimethylsiloxane and a relatively high concentration of mica. The composition of the present invention is useful as a coating for metal or plastic composites in lithium-ion battery packs.

Electric vehicles using lithium-ion batteries encased in aluminum or plastic composite housings are rapidly growing in market share. A pervasive problem associated with battery packs is thermal runaway, which causes the temperature to rise above 1000° C., which is sufficiently high to melt the aluminum or plastic with concomitant proliferation of fire and the release of molten particles. Although steel may be used in place of aluminum, the higher density of steel adversely impacts the range and performance of the electric vehicle. It would therefore be desirable to discover a coating material that can be applied to a battery pack casing or cover to protect against the consequences of thermal runaway and shield the occupants of the vehicle.

### SUMMARY OF THE INVENTION

The present invention addresses a need in the art by providing, in one aspect, a composition comprising a) a polyorganosiloxane functionalized with at least two Si—H groups and having a degree of polymerization in the range of from 2 to 400; b) a polyorganosiloxane functionalized with at least two vinyl groups and having a degree of polymerization up to 1000; c) micron-sized mica particles; and d) a hydrosilylation catalyst; wherein the concentration of the mica particles is in the range of from 90 to 200 parts by weight per 100 parts by weight of polyorganosiloxanes a) and b); and wherein the mole: mole ratio of Si—H groups in polyorganosiloxane a) to Si-vinyl groups in polyorganosiloxane b) is in the range of from 0.8:1 to 5:1. The composition of the present invention is useful as an insulator for battery cover.

### DETAILED DESCRIPTION OF THE INVENTION

The present invention is a composition comprising a) a polyorganosiloxane functionalized with at least two Si—H groups and having a degree of polymerization in the range of from 2 to 400; b) a polyorganosiloxane functionalized with at least two vinyl groups and having a degree of polymerization up to 1000; c) micron-sized mica particles; and d) a hydrosilylation catalyst; wherein the concentration of the mica particles is in the range of from 90 to 200 parts by weight per 100 parts by weight of polyorganosiloxanes a) and b); and wherein the mole: mole ratio of Si—H groups in polyorganosiloxane a) to Si-vinyl groups in polyorganosiloxane b) is in the range of from 0.8:1 to 5:1.

The polyorganosiloxane functionalized with at least two Si—H groups (polyorganosiloxane (a)) is preferably represented by formula I:

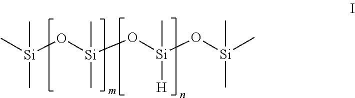

Where the sum of m+n is in the range of from 2 or from 3 to 400 or to 200 or to 100 or to 50, and wherein n is from 2 or from 3 to preferably 100 or to 50 or to 20.

In one embodiment, the polyorganosiloxane functionalized with at least two vinyl groups (polyorganosiloxane (b)) is a Q-branched polyorganosiloxane, as illustrated in formula II:

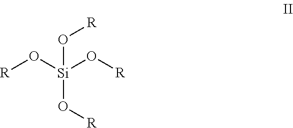

where each R is represented by fragment Ila:

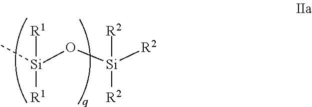

where each q is in the range of from 0 to 300 or to 250; each R¹ is independently C₁-C₆-alkyl; and each R² is R¹ or a C₁-C₆-alkenyl group; with the proviso that at least three of the R² groups are C₁-C₆-alkenyl groups. Preferably, each R¹ is methyl and at least three of the R² groups are vinyl groups. Preferably, each R is represented by fragment IIb:

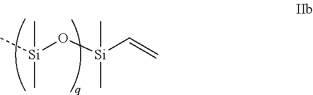

An example of a Q-branched polyorganosiloxane is tetrakis(vinyldimethylsiloxy) silane (fragment IIb, where q=0), available commercially from Gelest Inc. Q-branched polysiloxanes with q>0 may be prepared by an acid catalyzed equilibration reaction of tetrakis(vinyldimethylsiloxy) silane with octamethylcyclotetrasiloxane at advanced temperatures, followed by a neutralization step. Chain length (q) can be controlled by adjusting the relative amount of octamethylcyclotetrasiloxane.

In another embodiment, polyorganosiloxane (b) is a linear polyorganosiloxane with two terminal vinyl groups, as illustrated in formula III:

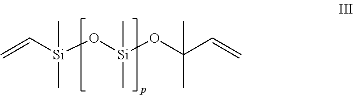

where p is in the range of from 2 or from 10, or from 40 or from 50, to 1000, or to 500, or to 250, or to 150.

In yet another embodiment, polyorganosiloxane (b) is a combination of polyorganosiloxane of formulas II and III, where the weight-to-weight ratio of the polyorganosiloxane of formula II to the polyorganosiloxane of formula III is preferably in the range of from 60:40 to 95:5.

The polyorganosiloxane (b) may further comprise a polyorganosiloxane resin functionalized with one or more ethylenically unsaturated groups, as illustrated in formulas IV and V:

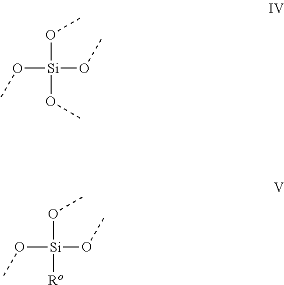

where R^{o} is methyl, ethyl, or phenyl, and the dashed lines represent the points of attachment to other groups.

The mole: mole ratio of Si—H groups of polyorganosiloxane (a) to vinyl groups of polyorganosiloxane (b) is preferably in the range of from 0.8:1 or from 0.9:1, to 5:1 or to 4:1 or to 3:1 or to 2:1 or to 1.5:1.

The micron-sized mica particles are muscovite or phlogopite particles present at a concentration in the range of from 90 or from 100 to 200 or to 180 or to 160 parts by weight (pbw) per 100 pbw of polyorganosiloxanes (a) and (b). As used herein, “micron-sized” refers to mica particles with a D₅₀ particle in the range of from 1 μm to 100 μm, as measured by laser diffraction. Surprisingly, a curable polyorganosiloxane mixture containing an inordinately high concentration of mica particles forms a crack-free ceramified coating under pyrolysis conditions. Ceramification causes an advantageous reduction in the thermal conductivity of the coating, which is particularly useful in a battery pack design to prevent burn-through of the battery pack substrates from heat, flame, and molten particles that can be released at high energy during a thermal runaway event. When the battery is used in an electric vehicle, ceramification can attenuate the exposure of these hazards to the vehicle occupants.

The composition may exhibit even greater resistance to pyrolysis as measured by a 3-point break test (described hereinbelow) with the further inclusion of one or more ancillary inorganic fillers or their hydrates such as aluminum trihydroxide (i.e., aluminum trihydrate or ATH), hydromagnesite, aluminum oxides, epsomite, nesquihonite, boehmite, huntite, magnesium hydroxides, magnesium oxides, cerium oxide, iron oxides, titanium oxide, zinc oxide, calcium carbonate, boron nitride, boron oxides, kaolin clays, ground quartz, and ground glass frits.

Additionally, wollastonite fibers, potassium titanate fibers, and glass fibers may be used as ancillary fillers to improve mechanical strength of the ceramified coating; moreover, hollow glass beads, hollow ceramics, and expanded perlite may be used to improve thermal insulation performance of the ceramified coating. Though not bound by theory, it is believed that the one or more ancillary fillers accelerate the ceramification reaction, thereby improving the mechanical strength or the thermal insulation of the composition after pyrolysis.

When used, the one or more ancillary fillers are present at such a concentration so that the total concentration of mica and ancillary fillers does not exceed 200 pbw per 100 pbw of polyorganosiloxanes (a) and (b). Accordingly, in an additional embodiment, the concentration of mica is in the range of 100 to 180 pbw or to 150 pbw and the concentration of the one or more ancillary fillers is in the range of from 5 to 50 pbw, per 100 pbw of polyorganosiloxanes (a) and (b).

The hydrosilylation catalyst is preferably a platinum-based catalyst used in a catalytic amount, typically in the range of from 0.5 ppm to 200 ppm of Pt, based on the weight of the composition. The catalyst may be unsupported or disposed on a solid support (e.g., carbon, silica, or alumina). The catalyst may be microencapsulated in a thermoplastic resin for increased stability during storage of the curable composition. The microencapsulated catalyst, which can be prepared as described in U.S. Pat. No. 4,766,176 or U.S. Pat. No. 5,017,654, may be heated to about the melting or softening point of the resin encapsulating the catalyst, thereby exposing the hydrosilylation catalyst to ingredients polyorganosiloxanes a) and b). Examples of suitable platinum-based catalysts include chloroplatinic acid and SYL-OFF™ 4000 Catalyst, which is a commercially available organo-platinum complex dispersed in a polysiloxane.

The viscosity of the formulation is preferably less than 300,000 cP, more preferably less than 200,000 cP, more preferably less than 100,000 cP, and most preferably less than 50,000 cP. The composition may optionally comprise a silicone polyether and silane filler treating agent to further reduce the viscosity of the composition, if desired, as well as a hydrosilylation inhibitor to adjust pot life. The composition may optionally comprise adhesion promoters.

The composition can be prepared in a one-part or two-part formulation. For two-part formulations, the parts can be mixed in a static or dynamic mixer prior to coating. Coating processes include spray-coating (e.g., flat-stream nozzle spraying), extrusion, or drawdown processes. The sample can be cured at a temperature typically in the range of from 20° C. to 175° C. after application of the coating, for a time generally in the range of from 10 minutes to 8 hours. One-part compositions typically use microencapsulated catalysts that are exposed to the reactants upon heating. The composition can also be molded and cured into a desired shape and adhered to a substrate, which includes metals and plastic composites. The composition coating thickness is generally in the range of from 0.5 mm to 10 mm.

In another aspect, the present invention is an article comprising a battery encased in a metal or plastic composite housing that is coated with the composition of the present invention.

### EXAMPLES

In the following examples, all components were mixed using a FlackTek Speed Mixer. Q-branched polymers A, B, and C are represented by formula II, where each R group, on average, is represented by fragment IIb:

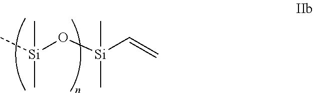

For Q-branched polymer A, n=124 (1.1 wt. % vinyl groups); for Q-branched polymer B, n=0 (23.3 wt. % vinyl groups); and for Q-branched polymer C, n=220 (0.6 wt. % vinyl groups). Inhibitor A is a blend of ethynylcyclohexanol (0.1 pbw) and polyorganosiloxane (b) of formula III where p=158 (99.9 pbw).

Viscosity measurements were taken on formulations of the inventive examples prepared separately without catalyst or inhibitor by mixing all other components together at 3000 rpm for 30 s. A viscosity versus shear rate sweep was performed using an Anton-Paar MCR 301 rheometer using a 25-mm parallel plate cell. The viscosity at 10 s⁻¹ was recorded.

### Comparative Example 1—Preparation of a 2-Part Composition with Mica Filler

A first component (Part A) was prepared by adding Q-branch Polymer A (49.67 pbw) and SYL-OFF™ 4000 Catalyst (0.33 pbw) to the mixer and mixing at 2000 rpm for 30 s. Imersy WG-325 Mica (20 pbw) was then added to the mixture, and mixing was continued at 3000 rpm for an additional 30 s.

A second component (Part B) was prepared by adding Q-branch Polymer A (41.12 pbw), polyorganosiloxane (a) of the formula MD_{3.2}D^{H}_{5.8}M (6.44 pbw), and Inhibitor A (2.44 pbw) to the mixer and mixing at 2000 rpm for 30 s. Imersy WG-325 Mica (20 pbw) was then added to the mixer, and mixing was continued at 3000 rpm for an additional 30 s.

Part A and B were combined at a 1:1 w/w ratio and mixed at 2000 rpm for 30 s. The blend was then placed into a 2-mm thick Teflon-coated mold and cured at 125° C. for 1 h. Disks or ½″×4″ rectangles were punched out of the cured molded samples, and the samples were pyrolyzed at 1000° C. using a Fisher Scientific isotemp programmable 750 series furnace, as follows. With the fan on, the temperature was ramped at a rate of 5 C°/min to 450° C., with a dwell for 19 h, then ramped at a rate of 5 C°/min to 500° C., with a dwell time of 2 h. The fan was then turned off, and the temperature was ramped at a rate of 1 C°/min to 1050° C., dwell for 2 h. The fan and the heating were then turned off, and the samples was allowed to cool to 25° C. Samples that showed cracking or didn't produce a solid structure were excluded from thermal conductivity or 3-point break testing after pyrolysis. Thermal conductivity (TC) before and after pyrolysis was measured using a HotDisk Thermal Constants Analyzer with a 50-mW pulse for 10 s. 3-Point break tests after pyrolysis were performed using a TA Instruments RSA-G2 Solids Analyzer (Linear Rheometer) with a 25-mm gap stage and a 13-mm single contact wedge attachment. The ½″×4″ sample was placed on the stage and the wedge lowered at 0.1 mm/s with force measurement. Force at break and cross-sectional area was used to calculate the 3-Point Break strength in MPa.

Comparative Examples 2 and 3 and Examples 1~4 were prepared substantially as described in Example 1, except for differences in filler concentrations and filler type, as illustrated in Table 1. Mica pbw refers pbw Imersy WG-325 Mica per 100 pbw of the sum of polyorganosiloxanes (a) and (b); Clay pbw refers to pbw of Glomax LL Calcined Kaolin Clay per 100 pbw of the sum of polyorganosiloxanes (a) and (b); SiH: Vi refers to the mole-to-mole ratio of SiH groups from polyorganosiloxane (a) to vinyl groups in polyorganosiloxane (b); Viscosity is in units of centipoise (cP), with viscosities less than 300,000 cP considered acceptable; TCₒ refers to the thermal conductivity of the samples prior to pyrolysis; and TC_{f} refers to thermal conductivity of samples after pyrolysis.

TABLE 1
Properties of Polyorganosiloxane Samples with Mica or Clay

| | Comp. 1 | Comp. 2 | Comp. 3 | Ex. 1 | Ex. 2 | Ex. 3 | Ex. 4 |
|---|---|---|---|---|---|---|---|
| Mica pbw | 40 | 85 | — | 92 | 127 | 143 | 185 |
| Clay pbw | — | — | 127 | — | — | — | — |
| SiH:Vi | 1.3 | 1.3 | 1.3 | 1.3 | 1.3 | 1.3 | 1.3 |
| Viscosity (cP) | 3000 | 12,000 | 15,000 | 16,000 | 35,000 | 41,000 | 200,000 |
| TCₒ (W/m · K) | 0.45 | 0.50 | 0.35 | 0.44 | 0.55 | 0.56 | 0.61 |
| TC_{f} (W/m · K) | N.A. | N.A. | N.A. | 0.20 | 0.22 | 0.18 | 0.25 |
| 3-pt. break | <0.1^{a} | <0.1^{a} | <0.1^{a} | 3.1 | 7.0 | 7.1 | 7.2 |
| (MPa) | | | | | | | |

^{a}These samples fell apart during pyrolysis and could not be accurately tested for 3-point break.

The data show that large concentrations of mica were effective in achieving samples that did not crack under rigorous pyrolysis conditions, and that acceptable viscosities and thermal conductivities were achieved with the inventive samples. Moreover, the inventive cured compositions showed a surprising and advantageous drop in thermal conductivity, which further promotes the desired thermal insulation.

Table 2 illustrates the effects of different vinyl-functionalized polymers on viscosity, thermal conductivity, and resistance to cracking after sample pyrolysis. The samples were prepared as in Example 2, except for differences in the vinyl-functionalized polymer (Vinyl Polymer). Q-B refers to Q-branched polymer B, Q-C refers to Q-branched polymer C, and linear refers to a linear polyorganosiloxane of formula III. Vinyl Polymer D.P. refers to the degree of polymerization of the Vinyl Polymer (n in formula IIb and p in formula III.)

TABLE 2
Effect of Vinyl Polymer on Sample Properties

| | Ex. 5 | Ex. 6 | Ex. 7 |
|---|---|---|---|
| Mica pbw | 127 | 127 | 127 |
| Vinyl Polymer | Q-B | Q-C | linear |
| Vinyl Polymer D.P. | 0 | 220 | 52 |
| SiH:Vi | 1.3 | 1.3 | 1.3 |
| Viscosity (cP) | 8,000 | 45,000 | 70,000 |
| TCₒ (W/m · K) | 0.60 | 0.58 | 0.47 |
| TC_{f} (W/m · K) | 0.19 | 0.13 | 0.24 |
| 3-point Break (MPa) | 15.6 | 5.9 | 6.3 |

The data show that all samples passed the pyrolysis testing, and that the samples prepared using Q-branched vinyl-functionalized polymers showed especially desirable viscosity and TC. Example 5 showed a marked increase in the 3-point break test, showing greater mechanical strength of the ceramified material and greater protection against thermal runaway.

The effects of using mica and an ancillary filler on viscosity, thermal conductivity, and resistance to cracking after sample pyrolysis are shown in Table 3. Experiments were carried out as described in Comparative Example 1 except that ancillary fillers were added along with the mica in amounts shown in Table 3. ATH pbw refers to parts by weight of Micral 855 Aluminum Trihydrate per 100 parts polyorganosiloxane (a) and (b); HCM pbw refers to parts by weight of Extendospheres HA Hollow Ceramic Microspheres per 100 parts polyorganosiloxane (a) and (b); and Wollastonite pbw refers to parts by weight of Nyad G Wollastonite per 100 parts polyorganosiloxane (a) and (b).

TABLE 3
Effect of Ancillary Fillers on Sample Properties

| | Ex. 2 | Ex. 8 | Ex. 9 | Ex. 10 |
|---|---|---|---|---|
| Mica pbw | 127 | 112 | 112 | 127 |
| ATH pbw | — | 44 | 12 | 14 |
| HCM pbw | — | — | 34 | — |
| Wollastonite pbw | — | — | — | 14 |
| SIH:Vi | 1.3 | 1.3 | 1.3 | 1.3 |
| Viscosity (cP) | 35,000 | 22,000 | 18,000 | 38,000 |
| TCₒ (W/m · K) | 0.55 | 0.71 | 0.51 | 0.53 |
| TC_{f} (W/m · K) | 0.20 | 0.23 | 0.15 | 0.22 |
| 3-Point Break (MPa) | 7.0 | 11.8 | 13.2 | 20.4 |

The data illustrate that the use of ancillary fillers have a somewhat lower viscosity and comparable or lower thermal conductivity compared with samples containing mica only. Example 10 in particular showed remarkable mechanical strength.

1. A composition comprising a) a polyorganosiloxane functionalized with at least two Si—H groups and having a degree of polymerization in the range of from 2 to 400; b) a polyorganosiloxane functionalized with at least two vinyl groups and having a degree of polymerization up to 1000; c) micron-sized mica particles; and d) a hydrosilylation catalyst; wherein the concentration of the mica particles is in the range of from 90 to 200 parts by weight per 100 parts by weight of polyorganosiloxanes a) and b); and wherein the mole: mole ratio of Si—H groups in polyorganosiloxane a) to Si-vinyl groups in polyorganosiloxane b) is in the range of from 0.8:1 to 5:1.

2. The composition of claim 1 wherein the polyorganosiloxane functionalized with at least two Si—H groups is a polyorganosiloxane of formula I: 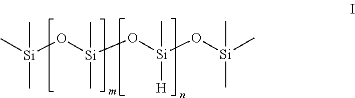
where the sum of m+n is in the range of from 2 to 400, and wherein n is from 2 to 100; and
wherein the polyorganosiloxane functionalized with at least two vinyl groups is a polyorganosiloxane of formula II: 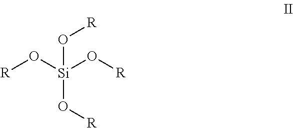
where each R is represented by fragment IIa: 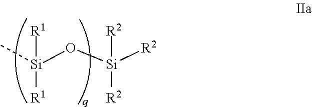
where each q is in the range of from 0 to 300; each R¹ is independently C₁-C₆-alkyl;
and each R² is R¹ or a C₁-C₆-alkenyl group; with the proviso that at least three of the R² groups are C₁-C₆-alkenyl groups;
wherein the hydrosilylation catalyst is a platinum-based catalyst.

3. The composition of claim 2 wherein each R is represented by fragment IIb: 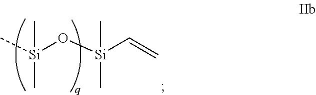
the sum of m+n is in the range of from 3 to 200; and n is in the range of 3 to 100;
wherein the mole: mole ratio of Si—H groups in polyorganosiloxane a) to Si-vinyl groups in polyorganosiloxane b) is in the range of from 0.9:1 to 3:1.

4. The composition of claim 1 wherein the polyorganosiloxane functionalized with at least two Si—H groups is a polyorganosiloxane of formula I: 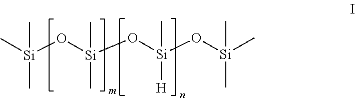
where the sum of m+n is in the range of from 2 to 400, and wherein n is from 2 to 100; and
wherein the polyorganosiloxane functionalized with at least two vinyl groups is a linear polyorganosiloxane of formula III: 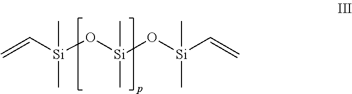
where p is in the range of from 2 to 1000;
wherein the hydrosilylation catalyst is a platinum-based catalyst.

5. The composition of claim 1 wherein the polyorganosiloxane functionalized with at least two Si—H groups is a polyorganosiloxane of formula I: 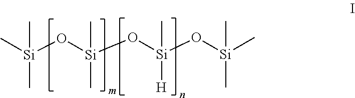
where the sum of m+n is in the range of from 2 to 400, and wherein n is from 2 to 100; and wherein the polyorganosiloxane functionalized with at least two vinyl groups is a combination of a polyorganosiloxane of formula II: 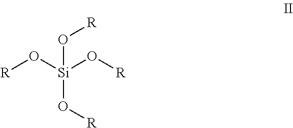
where each R is represented by fragment IIb: 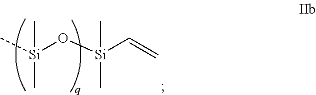
and a linear polyorganosiloxane of formula III: 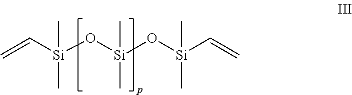
where p is in the range of from 2 to 1000;
wherein the hydrosilylation catalyst is a platinum-based catalyst.

6. The composition of claim 5 wherein the weight-to-weight ratio of the polyorganosiloxane of formula II to the polyorganosiloxane of formula III is in the range of from 60:40 to 95:5; wherein the mole: mole ratio of Si—H groups in polyorganosiloxane a) to Si-vinyl groups in polyorganosiloxane b) is in the range of from 0.9:1 to 2:1.

7. The composition of claim 1 which further comprises one or more ancillary inorganic fillers, wherein the total concentration of mica and the one or more ancillary fillers does not exceed 200 parts by weight per 100 parts by weight of polyorganosiloxanes a) and b); wherein the hydrosilylation catalyst is a platinum-based catalyst.

8. The composition of claim 3 which further comprises one or more ancillary inorganic fillers selected from the group consisting of aluminum trihydrate, hydromagnesite, aluminum oxides, magnesium oxides, cerium oxide, iron oxides, titanium oxide, zinc oxide, calcium carbonate, boron nitride, boron oxides, kaolin clays, ground quartz, ground glass frits, wollastonite, potassium titanate fibers, glass fibers, hollow glass beads, hollow ceramics, and expanded perlite; wherein the concentration of the mica particles is in the range of from 100 to 160 parts by weight per 100 parts by weight of polyorganosiloxanes a) and b), and the total concentration of the one or more ancillary fillers is in the range of from 5 to 50 parts by weight, per 100 parts by weight of polyorganosiloxanes a) and b), with the proviso that the total concentration of mica and the one or more ancillary fillers does not exceed 200 parts by weight per 100 parts by weight of polyorganosiloxanes a) and b); wherein the mole: mole ratio of Si—H groups in polyorganosiloxane a) to Si-vinyl groups in polyorganosiloxane b) is in the range of from 0.9:1 to 2:1.

9. The composition of claim 8 wherein the one or more ancillary inorganic fillers is selected from the group consisting of aluminum trihydrate, hollow ceramic microspheres, and wollastonite.

10. An article comprising a battery encased in a metal or plastic composite housing that is coated with the composition of claim 1.
